(19) United States
(12) Patent Application Publication
(10) Pub. No.: US 2006/0061005 A1
(43) Pub. Date: Mar. 23, 2006

(54) Method of producing layered polymeric articles

(76) Inventors: Henry Peng, Richmond Hill (CA); Lucie Martineau, Kettleby (CA); Peng Shek, Toronto (CA)

Correspondence Address: George A. Seaby, Seaby & Associates, 603 - 250 City Centre Ave., Ottawa, ON, K1R 6K7, CA

(21) Appl. No.: 11/231,009

(22) Filed: Sep. 21, 2005

Related U.S. Application Data
(60) Provisional application No. 60/611,714, filed on Sep. 22, 2004.

(51) Int. Cl. B29C 47/06

(52) U.S. Cl. 264/173.16; 264/203

(57) ABSTRACT

A first polymer is coated with a second polymer by placing the polymers separately in the barrels of a double-barrelled extruder, and extruding the polymers through a common orifice into a coagulation solution. For example, a core of an absorbent, thermoplastic polyurethane hydrogel can be coated with gelatin to form an absorbent fiber.

### CROSS REFERENCE TO RELATED APPLICATION

This application claims priority on U.S. Provisional Application 60/611,714 filed Sep. 22, 2004.

### BACKGROUND OF THE INVENTION

1. Field of the Invention

This invention relates to a method of producing layered polymeric articles, and in particular biomedical, polymer coated fibers and particles.

2. Discussion of the Prior Art

Polymer-coated articles such as fibers and particles are used in a variety of biomedical applications. Several techniques have been described for coating fibers and particles with a polymer. Such methods include solution casting/dipping, surface polymerization, immobilization, complexation and chemical vapor deposition. For example chitosan or gelatin-coated particles have been prepared by casting solutions containing the polymers onto poly(caprolactone) particles previously produced by a hot-melt method. Similarly, laminin-coated collagen fibers have been prepared for nerve regeneration. Current coating methods involve a plurality of steps and result in articles with layered coatings.

Solution coagulation is another method of forming articles containing a mixture of polymers. To the best of the inventors' knowledge, such a method has been used only to produce polymer fibers and particle-containing articles of mixed composition. For example, blended fibers of polysaccharides and proteins have been prepared by spinning the ingredients into a coagulation solution. Chitosan and alginate particles have been prepared by adding droplets of an alginate solution to a mixture containing calcium chloride and chitosan. A one-step process for preparing polymer-coated or dual-layered fibers using a co-extrusion process has been reported. In the process each polymer solution was extruded separately and coagulated at the same time to prevent delamination, but it requires a complex spinneret design with two orifices.

### GENERAL DESCRIPTION OF THE INVENTION

The object of the present invention is to provide a relatively simple method of coating a first polymer with a second polymer by solution coagulation.

Accordingly, the invention relates to a method of coating a first polymer with a second polymer comprising the steps of placing said first polymer in one barrel of a double-barrelled extruder having a common extrusion orifice; placing said second polymer in a second barrel of the double-barrelled extruder; and extruding said first and second polymers through said common orifice into a coagulation solution, whereby said first polymer forms a core and said second polymer coats the core.

More specifically, solutions of different polymers are extruded together into a coagulation solution. Under appropriate conditions, the extruded polymers can be coagulated at different rates. As a result, the polymer that is first coagulated will form a core while the polymer coagulated later will coat the core. It has been found that surface compositions change as coagulation conditions change. Moreover, the method can be used to form an article with a gradient from one component to another component by controlling coagulation rates.

### BRIEF DESCRIPTION OF THE DRAWINGS

The invention is described below in greater detail with reference to the accompanying drawings, wherein:

FIG. 1 shows FTIR spectra of various fibers produced according to the method of the present invention; and

FIG. 2 is a photograph of a gelatin-coated HydroThane fiber with the gelatin partially peeled off the fiber (HydroThane is a registered trademark of Cardiotech International Inc. of Woburn, Mass. claimed to be for a superabsorbent, thermoplastic polyurethane hydrogel).

### DESCRIPTION OF THE PREFERRED EMBODIMENT

When producing a wound dressing using the method of the present invention, a hydrophilic, biocompatible first component selected from the group consisting of a biopolymer and a synthetic polymer is used to coat a hydrophobic second component, which is a biocompatible elastomer.

The hydrophilic first component is selected from the group consisting of polyvinyl alcohol, polyhydroxymethacrylate, polyethylene oxides, acrylamides, hydrophobically modified hydrogels, collagen, gelatin, fibronectin, cellulose, hydroxypropyl cellulose, hydroxypropylmethyl cellulose, methyl cellulose, ethyl cellulose, carboxymethyl cellulose, carboxyethyl cellulose, a modified gelatin, alginate and oxidized cellulose, the preferred component being gelatin or a modified gelatin, specifically methacrylated gelatin. This material is hydrophilic, absorbent, biocompatible and possesses known hemostatic properties. The incorporation of gelatin into a wound dressing for application to hemmorrhagic living tissues would be expected to promote hemostasis.

Suitable hydrophobic second components include siloxane and polyurethane polymers such as polydimethylsiloxanes or vinyl containing siloxanes or polymethylhydrosiloxanes, polyethylene-vinylacetate (EVA), polytetramethylene oxide (PTMO), and HydroThane, the latter being preferred.

### EXAMPLE

A gelatin-coated HydroThane™ fiber was prepared using a Baxter Duploject device. One-mL aliquots of a

7.5% w/w gelatin solution in dimethylsulfoxide (DMSO) and a 4% w/w HydroThane AR 25-80A solution in DMSO were loaded into a double-barrelled 1-mL syringe with a common hub and ejection orifice (needle). The solutions were mixed as they were extruded manually through an 18 G needle into (1) a 95% ethanol and 5% water solution (2) 100% methanol, or (3) a 5% glutaraldehyde in methanol solution. The gelatin solution was also extruded in methanol, while that of HydroThane was extruded in 95% ethanol. The fibers thus formed were removed from the solution after 15 min and air-dried at room temperature in a fume hood until constant weight was reached. The formation of gelatin-coated HydroThane fibers was confirmed using Fourier Transformation Infrared Spectroscopy (FTIR) with an attenuated total reflectance accessory.

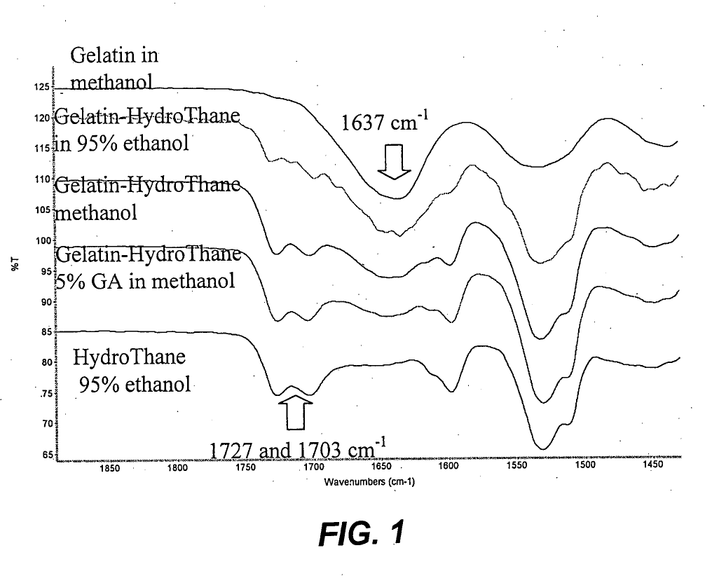

FIG. 1 shows the surface compositions of the fibers made by extruding the gelatin and HydroThane solutions into the different coagulation solvents. In addition, the polymer solutions were extruded individually to confirm they would coagulate and form a fiber in the solvent. The spectral analysis of gelatin fibers extruded in methanol shows a peak at 1637 cm⁻¹, likely due to the amide group of gelatin. The urethane group of HydroThane is responsible for the peaks observed at 1727 and 1703 cm⁻¹ when extruding HydroThane fibers in 95% ethanol. Based on the relative intensity of these characteristic peaks, the data shows that the gelatin component of the gelatin-HydroThane fiber made in 95% ethanol was mainly located on its surface in comparison with that made in methanol. This is due to the fact that the rate of gelatin coagulation in ethanol compared to that of HydroThane is slower in ethanol than in methanol. As a result, HydroThane coagulated first to form a fiber, soon followed by gelatin coagulation which coated the fiber. Moreover, the data show that the gelatin coating may also be cross-linked in the presence of glutaraldehyde in the coagulation solution to increase the coating stability and strength.

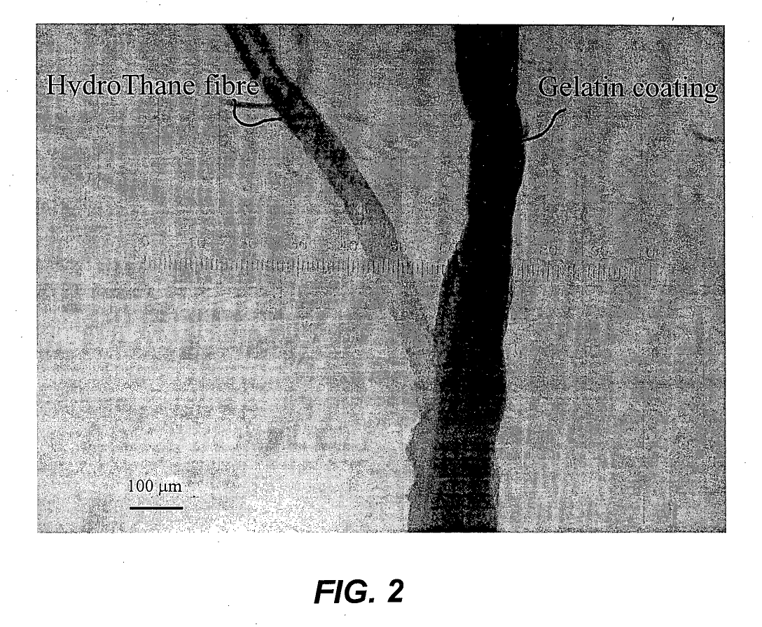

The gelatin-coated HydroThane fiber prepared in 95% ethanol was analyzed by light microscopy. FIG. 2 shows the gelatin coating peeled off from the inner HydroThane component at one extremity of the fiber. This is consistent with the FTIR result for the fiber prepared in the 95% ethanol coagulation solvent shown in FIG. 1.

Thus, there has been provided a one-step, solution-coagulation method of producing polymeric articles including a plurality of layered polymers, and in particular a method of producing gelatin-coated HydroThane fiber in which the HydroThane defines the core of the fiber.

1. A method of coating a first polymer with a second polymer comprising the steps of placing said first polymer in one barrel of a double-barrelled extruder having a common extrusion orifice; placing said second polymer in a second barrel of the double-barrelled extruder; and extruding said first and second polymers through said common orifice into a coagulation solution, whereby said first polymer forms a core and said second polymer coats the core.

2. The method of claim 1, wherein said first polymer is biocompatible and hydrophobic, and said second polymer is biocompatible and hydrophilic.

3. The method of claim 1, wherein said first polymer is an absorbent, thermoplastic polyurethane hydrogel and said second polymer is gelatin.

4. The method of claim 3, wherein a solution of the polyurethane hydrogel in a solvent selected from the group consisting of dimethylsulfoxide and chloroform is loaded into said one barrel, and a solution of gelatin in a solvent selected from the group consisting of dimethylsulfoxide, formamide and acetamide is loaded into said second barrel; and the solutions are extruded into a coagulation solution selected from the group consisting of 95% ethanol in water, 100% methanol and 5% glutaraldehyde in methanol.
